(19) United States
(12) Patent Application Publication
(10) Pub. No.: US 2025/0297424 A1
(43) Pub. Date: Sep. 25, 2025

(54) SYSTEM AND METHOD FOR APPLYING AN ADHESIVE POWDER TO A PRINTED TRANSFER FILM

(71) Applicant: Vastex International Inc., Bethlehem, PA (US)

(72) Inventor: Mark Vasilantone, Bethlehem, PA (US)

(73) Assignee: Vastex International Inc., Bethlehem, PA (US)

(21) Appl. No.: 19/087,007

(22) Filed: Mar. 21, 2025

Related U.S. Application Data
(60) Provisional application No. 63/568,012, filed on Mar. 21, 2024.

(51) Int. Cl. D06P 5/24; B41J 11/00; B41M 7/02; B65G 65/40

(52) U.S. Cl. CPC D06P 5/003; B65G 65/40; B41J 11/0015; B41M 7/02

(57) ABSTRACT

A device for applying an adhesive powder to a transfer film is disclosed. The device houses a film tray arranged to receive a transfer film thereon. A first hopper is mounted at an upper position above the film tray to receive an adhesive powder therein for release onto a transfer film during a coating process. A second hopper is mounted at a lower position below the film tray to collect excess adhesive powder fallen from the transfer film. Upon being emptied of adhesive powder, the first hopper may be removed from the upper position to replace the second hopper in the lower position, and the second hopper may be removed from the lower position to replace the first hopper in the upper position to enable release of the excess adhesive powder from the second hopper onto a transfer film in a subsequent coating process.

### FIELD OF THE DISCLOSURE

The present invention relates generally to film coating devices and, more particularly, to a film coating device that facilitates efficient usage of adhesive powder, and efficient operation for applying the adhesive powder onto films such as transfer films that have been printed with a graphic for transferring onto textiles such as clothing items.

### BACKGROUND OF THE INVENTION

Direct-to-Film (DTF) printing is a process for printing on textiles. The process involves the direct transfer of a graphic image by first printing it on a transfer film and then using a heat press to transfer the design to a garment. DTF is used on textiles including apparel such as T-shirts, jeans, jackets, hoodies, sportswear, and accessories like bags and belts. DTF has become increasingly popular for its versatility and ability to create vibrant designs on these substrates.

A key step in the DTF process involves applying an adhesive powder to the transfer film once the film has been printed with a graphic image. Traditional DTF methods involve hand-coating the printed transfer film with an adhesive powder in an open plastic container by manually shaking the container in which the transfer film and the adhesive powder are placed. The adhesive powder adheres to the printed areas of the transfer film. Close operator attention is required to obtain reliable results. Such manual shaking can be time-consuming and may result in non-uniform application of the adhesive powder on the transfer film. Also, manual shaking can be wasteful, resulting in spillage. Most importantly, manual shaking may expose the operator to adhesive dust which if inhaled could result in adverse health consequences.

Other DTF methods involve roll-to-roll printing which includes automatic power, shaker, and dryer attachments. The roll-to-roll method uses a continuous sheet of material during the entire process, from start to finish. In a roll-to-roll system, a rolled substrate is unrolled to undergo processing, such as cutting, lamination, coating, etc., and then re-rolled when it is completed. Despite the automated processes, roll-to-roll systems include additional drawbacks, such as challenges to maintaining dimensional accuracy due to the need for sophisticated tension control systems, additional mechanical complexity requiring specialized equipment, and higher costs per unit compared to DTF methods for smaller print runs. DTF printing can also be accomplished by using repurposed single pallet inkjet printers that formerly have been used for Direct-to-Garment (DTG) printing, which is more cost effective for smaller print runs.

FIG. 1 is a perspective view of a desktop powder shaker 100 that is commercially available. The desktop powder shaker 100 is a compact machine which is designed for use on a workbench or desktop. This makes the powder shaker 100 ideal for users with limited workspace, particularly small businesses or hobbyists venturing into DTF printing. The desk-top powder shaker 100 includes an enclosed chamber 102 for adhesive powder application. The chamber 102 is sized to enclose a single sheet of film 104 and includes a door 106.

Some devices with an L-shaped design optimize the use of space by minimizing their footprint. Unlike manual shaking, these machines automate the powder application process. This ensures consistent powder distribution across the transfer film, leading to better quality prints. The adhesive powder adheres to the printed areas of the transfer film and falls from the non-printed areas of the transfer film into a collecting container. Additionally, automation reduces processing time and labor costs, improving overall workflow efficiency. Some desktop powder shakers include an integrated curing oven. This eliminates the need for separate curing equipment, simplifying the workflow. The transfer film is placed in the unit, shaken with adhesive powder, and then automatically cured within the same machine. This streamlined approach saves space and allows for a more controlled curing process.

However, existing desktop adhesive powder shakers often struggle to deliver uniform adhesive powder coating, leading to inconsistencies in print quality. Existing adhesive powder shakers have complex operative mechanisms that are awkward to manipulate and inconvenient. Such existing adhesive powder shakers may generate significant dust and spillage, causing wastage of adhesive powder, and require frequent cleaning, which may add production costs. Furthermore, lack of proper enclosures exposes operators to adhesive dust, posing potential health risks. Also, the bulky and stationary design of existing adhesive powder shakers limits workspace efficiency.

### SUMMARY OF THE INVENTION

Various details of the present disclosure are hereinafter summarized to provide a basic understanding. This summary is not an extensive overview of the disclosure and is neither intended to identify certain elements of the disclosure, nor to delineate the scope thereof. Rather, the primary purpose of this summary is to present some concepts of the disclosure in a simplified form prior to the more detailed description that is presented hereinafter.

According to an embodiment consistent with the present invention, a film coating device comprises a chamber that is enclosed with a film tray for receiving a transfer film. An upper hopper of the film coating device is detachably mounted above the chamber for receiving an adhesive powder. The upper hopper transfers the adhesive powder onto the transfer film placed on the film tray during a coating process. A lower hopper of the film coating device is detachably mounted below the film tray in the chamber for collecting an excess of adhesive powder that falls from the transfer film during the coating process. The lower hopper has a design that is substantially identical to that of the upper hopper, making the lower hopper interchangeable with the upper hopper to enable reuse of the excess adhesive powder collected in the lower hopper in a subsequent coating process.

A lever is operably connected to the upper hopper and the film tray to activate the coating process when operated. The lever is operated in a first direction to enable the upper hopper to activate and release the adhesive powder onto the film tray to coat the transfer film. The lever is operated in a second direction to enable the film tray to oscillate for a set time period for allowing the excess adhesive powder to flow into the lower hopper.

According to another embodiment consistent with the present disclosure, a method for coating a transfer film using the film coating device is disclosed. The method comprises placing a transfer film on the film tray which is enclosed inside the chamber. The method comprises filling the upper hopper with the adhesive powder and mounting the upper hopper above the chamber for transferring the adhesive powder onto the transfer film placed on the film tray during the coating process. The method comprises mounting the lower hopper below the film tray in the chamber for collecting an excess adhesive powder that falls from the transfer film during the coating process. The method comprises closing the door of the chamber.

The method comprises operating the lever in the first direction for enabling the upper hopper to activate and release the adhesive powder onto the film tray to coat the transfer film. The lever is operably connected to the upper hopper and the film tray to activate the coating process when operated. The method comprises operating the lever in the second direction for enabling the film tray to oscillate for a set time period for allowing the excess adhesive powder to flow into the lower hopper.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

The present invention will hereinafter be described in conjunction with the appended drawing figures wherein like numerals denote like elements.

FIG. 1 is a perspective view of a prior art desktop powder shaker;

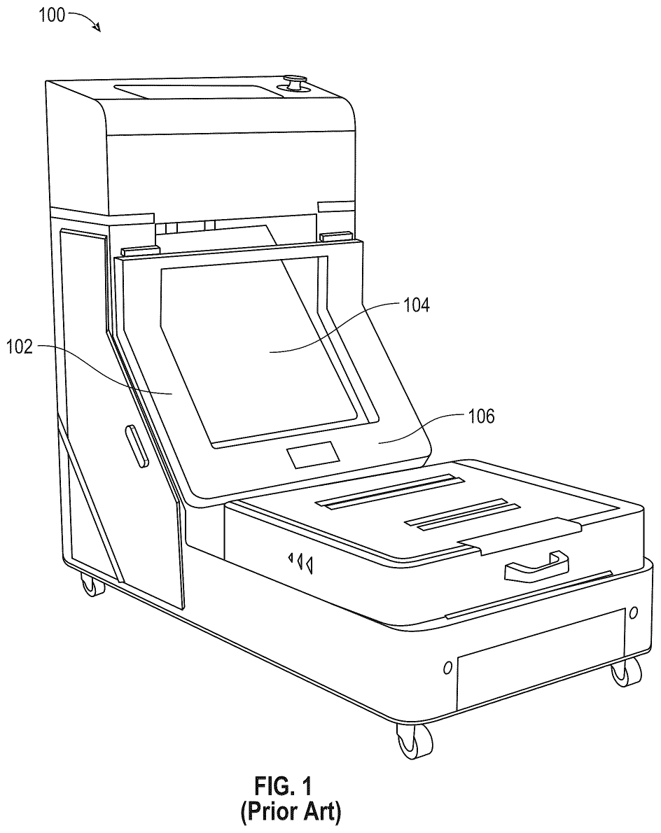

FIG. 2 is a perspective view of the film coating device of the present invention shown mounted on a metal cart;

FIG. 3 is a perspective rear view of the film coating device of the present invention mounted on the metal cart;

FIG. 4 is a perspective front view of the film coating device of the present invention illustrating the door of the chamber in an open position;

FIG. 5 is a perspective front view of the film coating device of the present invention depicting upper and lower hoppers detachably mounted above and below the film tray inside the chamber;

FIG. 6 is another perspective front view of the film coating device of the present invention;

FIGS. 7a and 7b are perspective front and back views of the film coating device of the present invention;

FIGS. 7c and 7d are perspective views of the exhaust unit and intake unit of the film coating device of the present invention;

FIGS. 8a and 8b are perspective views of the upper and lower hoppers of the film coating device of the present invention;

FIG. 9 is a perspective view of the film coating device of the present invention illustrating swapping of the upper and lower hoppers;

FIGS. 10a and 10b are perspective views of the upper and lower hoppers of the film coating device of the present invention;

FIG. 11 is a perspective view illustrating details of a film tray of the film coating device of the present invention;

FIGS. 12a through 12f is a flow diagram illustrating operation of the film coating device of the present invention;

FIGS. 13a and 13b are enlarged perspective views illustrating details of the exhaust unit of the film coating device of the present invention; and,

FIG. 14 is a flow diagram illustrating a method for coating a transfer film using the film coating device of the present invention.

### DETAILED DESCRIPTION OF THE PREFERRED EMBODIMENTS

Embodiments of the present disclosure will now be described in detail with reference to the accompanying Figures. Like elements in the various figures may be denoted by like reference numerals for consistency. Further, in the following detailed description of embodiments of the present disclosure, numerous specific details are set forth in order to provide a more thorough understanding of the claimed subject matter. However, it will be apparent to one of ordinary skill in the art that the embodiments disclosed herein may be practiced without these specific details. In other instances, well-known features have not been described in detail to avoid unnecessarily complicating the description. Additionally, it will be apparent to one of ordinary skill in the art that the scale of the elements presented in the accompanying Figures may vary without departing from the scope of the present disclosure.

Embodiments in accordance with the present disclosure generally relate to film coating devices. Herein is proposed a portable design of a film coating device that facilitates efficient usage of adhesive powder, and efficient operation for applying the adhesive powder onto transfer films.

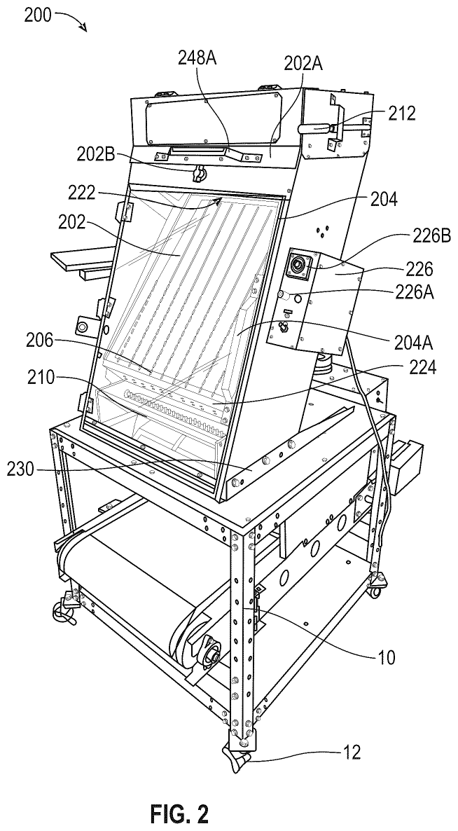

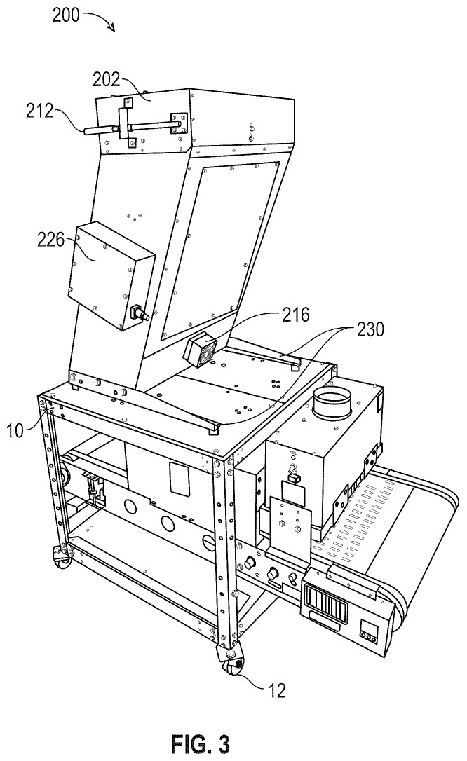

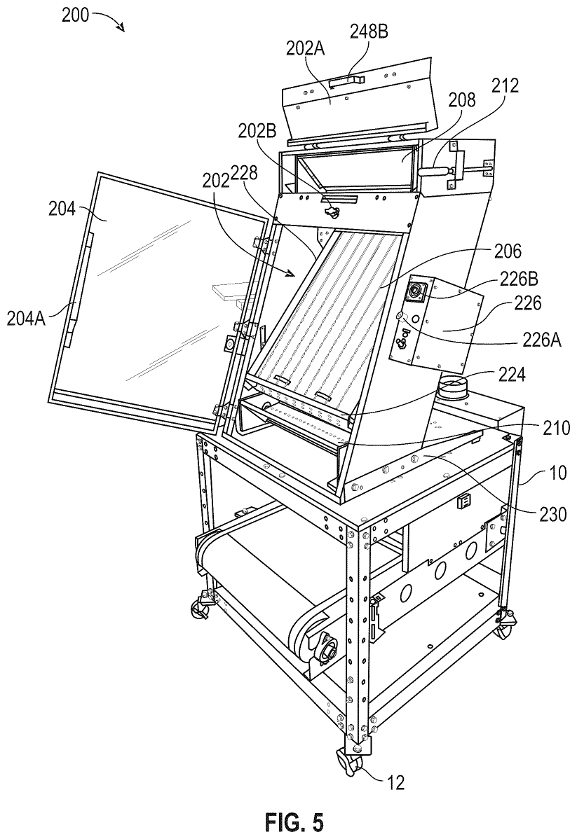

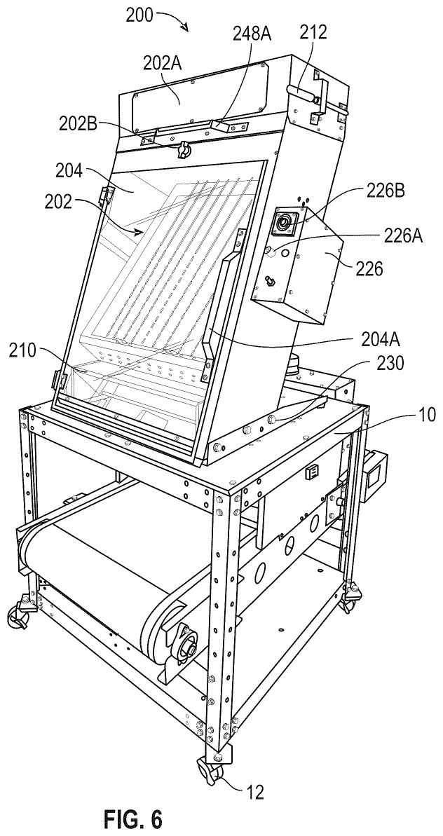

FIGS. 2 through 6 and FIGS. 7a and 7b refer to different perspective views of a film coating device 200 of the present invention. The film coating device 200 may be utilized as part of a screen-printing process. Referring to FIGS. 2 to 6, the film coating device 200 is shown mounted on top of a mobile stand 10, the mobile stand 10 having wheels 12 for mobility. The film coating device 200 is detachably attached to a pair of supporting legs 230 on either side of the film coating device 200 to provide stability during operation. The mobile stand 10 is provided with space underneath which could be utilized for the installation of one or more drawers (not shown) for storage of transfer films and/or adhesive powder used during the DTF printing process, or for housing a conveyor dryer also used during the DTF printing process. Alternatively, the film coating device 200 may be mounted on a tabletop.

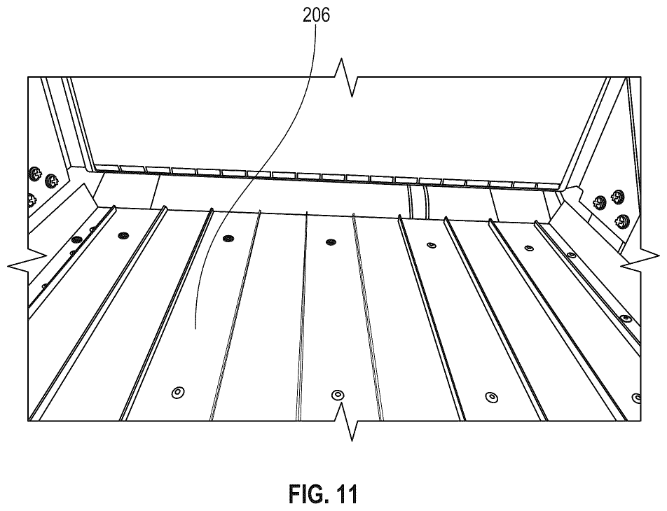

In one embodiment, the film coating device 200 comprises a chamber 202 having a door 204 that is attached by hinges. As shown in FIGS. 2, 4 through 6, and 11, the chamber 202 defines an enclosed volume that is arranged to receive a film tray 206 therein. The film tray 206 may include a film-receiving surface that is substantially planar and a plurality of ribs extending outwardly from the planar surface. The film tray 206 is shaped and positioned to receive individual sheets of a transfer film 252, e.g., a DTF film, thereon. The sheet size of the transfer film 252 may vary. For example, the transfer film 252 may be 19″ to 20″ in height or may be 16″/A3 or smaller. The film tray 206 may be provided with adjustable clips arranged to be affixed within slots located on the surface of the film tray 206 to enable adjustment of the location of the transfer film 252 on the film tray 206 to a desired position based on the size of the transfer film 252. As best shown in these figures, the film tray 206 may be oriented at an angle of inclination within the chamber 202. For example, when the film coating device 200 is positioned on a horizontal surface, the film tray 206 may be oriented at an acute angle of at least 5 degrees from vertical. Preferably, the film tray 206 may be oriented at an angle between 5 degrees and 45 degrees from vertical, and more preferably, between 5 degrees and 30 degrees from vertical. In a preferred embodiment, the door 204 is made of a material that comprises at least one of polycarbonate, acrylic, triacetate, polyethylene terephthalate glycol, polystyrene, or other suitable materials. The door 204 may be made of a transparent material to enable an operator to visually monitor during a coating process.

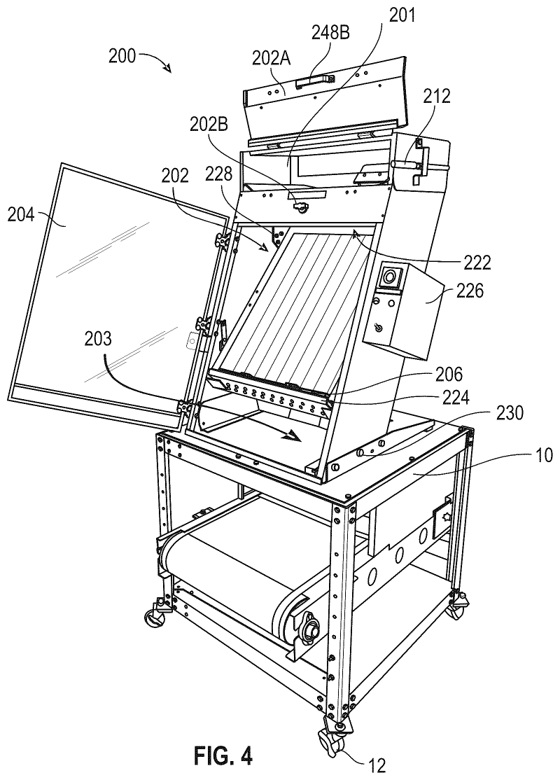

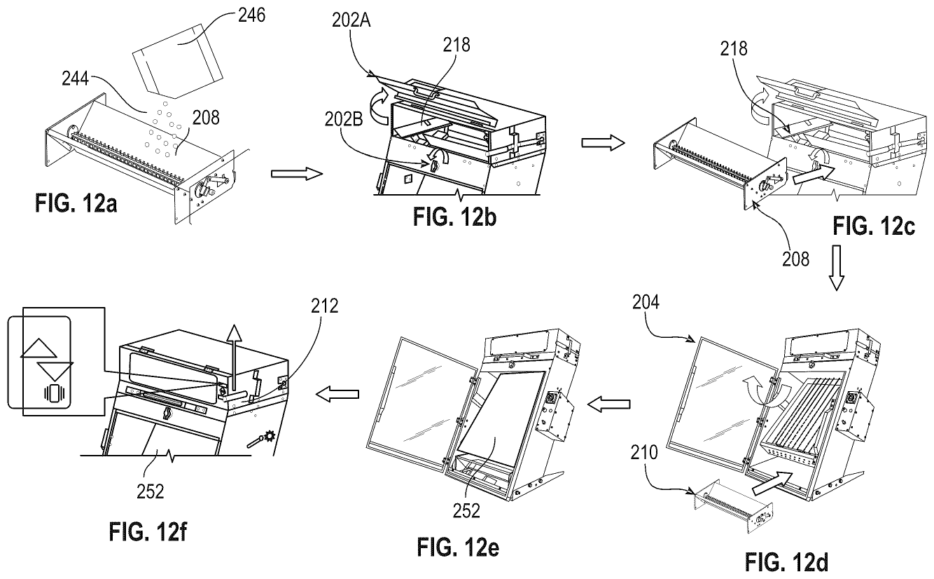

In one embodiment, an upper hopper 208 of the film coating device 200 is detachably mounted within an upper hopper-receiving chamber 201 (FIG. 4) above the chamber 202 for receiving an adhesive powder 244 (FIG. 12a) which may be dispensed from a bag 246. The upper hopper 208 transfers the adhesive powder 244 onto the transfer film 252 placed on the film tray 206 during the coating process.

In one embodiment, an upper access door 202A is provided above the chamber 202, which provides access to the upper hopper 208. The upper access door 202A features a latch 202B which is designed for secure opening and closing of the upper access door 202A. The latch 202B is in the form of a knob that is arranged for 90-degree rotational movement for opening and closing the upper access door 202A.

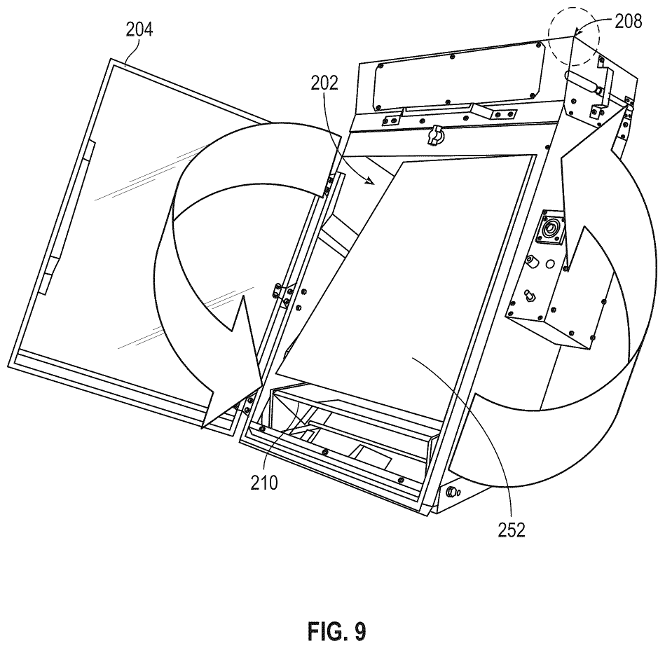

In one embodiment, a lower hopper 210 of the film coating device 200 is detachably mounted below the film tray 206 within a lower hopper chamber 203 (FIG. 4) of the chamber 202 for collecting an excess adhesive powder 244 that falls from the film tray 206 during the coating process. The lower hopper 210 is preferably substantially identical to the upper hopper 208. In this manner, the upper hopper-receiving chamber 201 and the lower hopper-receiving chamber 203 are adapted to removably receive either of the hoppers 208, 210. Thus, the lower hopper 210 is interchangeable with the upper hopper 208 to enable reuse of the excess adhesive powder 244 collected in the lower hopper 210 in subsequent coating processes, as shown in FIG. 9.

The upper hopper 208 holds and distributes the adhesive powder 244 over the transfer film 252 (FIGS. 12a through 12f). Unused adhesive powder 244 that does not adhere to the transfer film 252 falls to the bottom of the chamber 202 where the lower hopper 210 collects it.

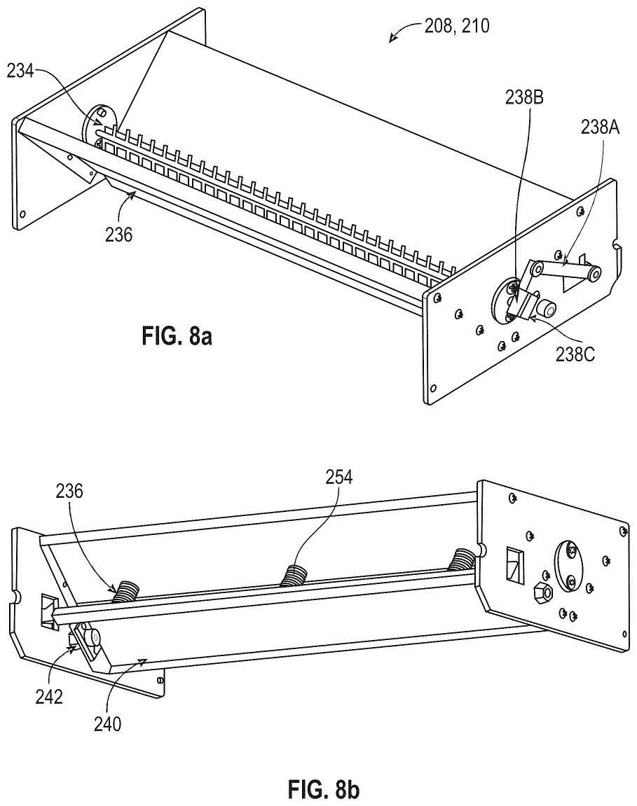

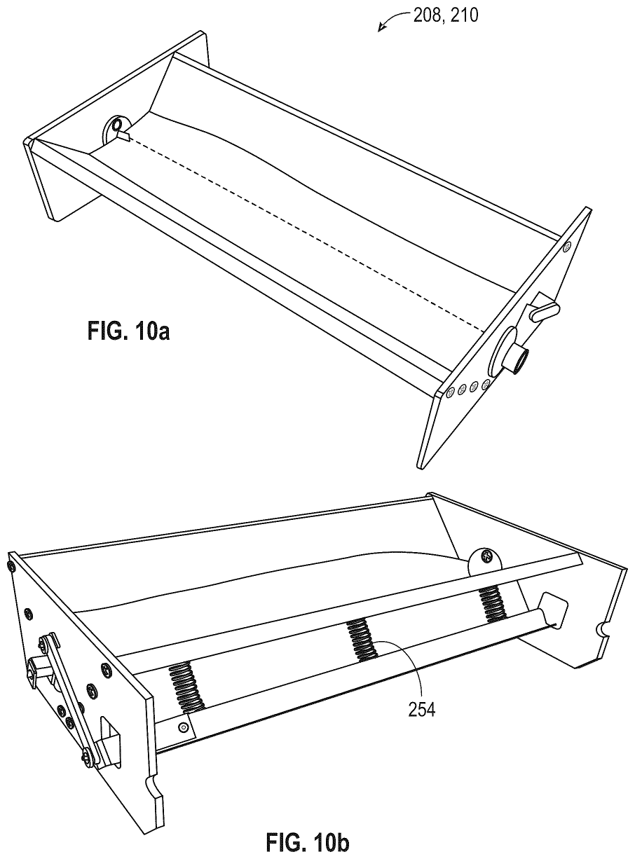

Referring to FIGS. 8a, 8b, 10a, and 10b, each hopper 208, 210 is detachably mounted in the film coating device 200 through a latching unit. Each hopper 208, 210 comprises an agitator 234, a powder seal 236, a set of pivot arms 238A, 238B, and a powder retaining plate 240. The agitator 234 is operably positioned within each hopper 208, 210 to agitate the adhesive powder 244 and ensure good flow. In a preferred embodiment, the powder seal 236 is a strip of adhesive-backed foam provided to seal bottom of each hopper 208, 210 to prevent leakage of the adhesive powder 244. Springs 254 may be provided to exert a clamping force against the powder seal 236 also to prevent leakage of the adhesive powder 244.

The set of pivot arms 238A, 238B is operably connected to the agitator 234 and are adapted to transmit force to the agitator 234, upon actuation. In one embodiment, the set of pivot arms 238A, 238B consists of a long pivot arm 238A arranged to actuate a short pivot arm 238B securely fastened to the agitator 234 to activate the agitator 234. The long and short pivot arms 238A, 238B can be made of any suitable plastic or metal material. Additionally, a set of pivot arm screws 238C may be utilized to clamp the pivot arms 238A, 238B onto the agitator 234. In a preferred embodiment, this set comprises at least 10 to 32 screws.

In one embodiment, a powder retaining plate 240 is disposed within each hopper 208, 210, the powder retaining plate 240 being configured to retain the adhesive powder 244 therein. A bushing 242 may be disposed on either end of the powder retaining plate 240 to secure the powder retaining plate 240 within the hopper 208, 210.

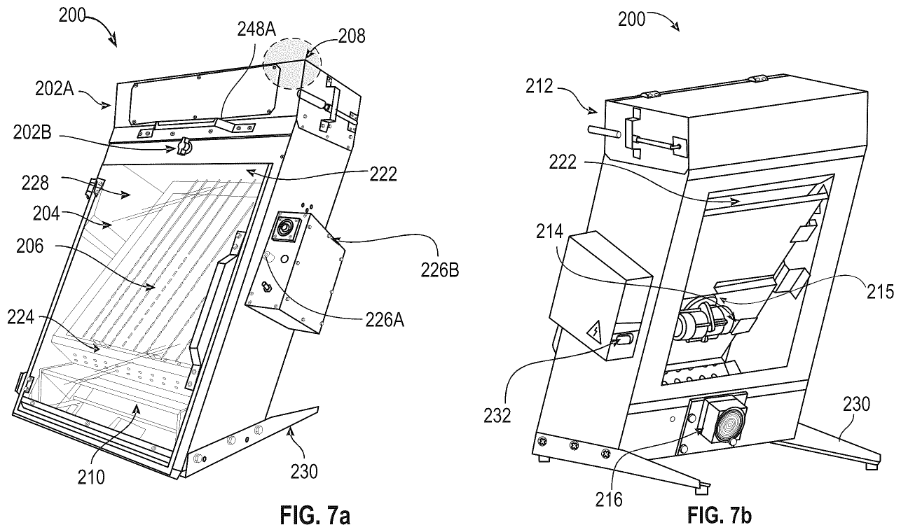

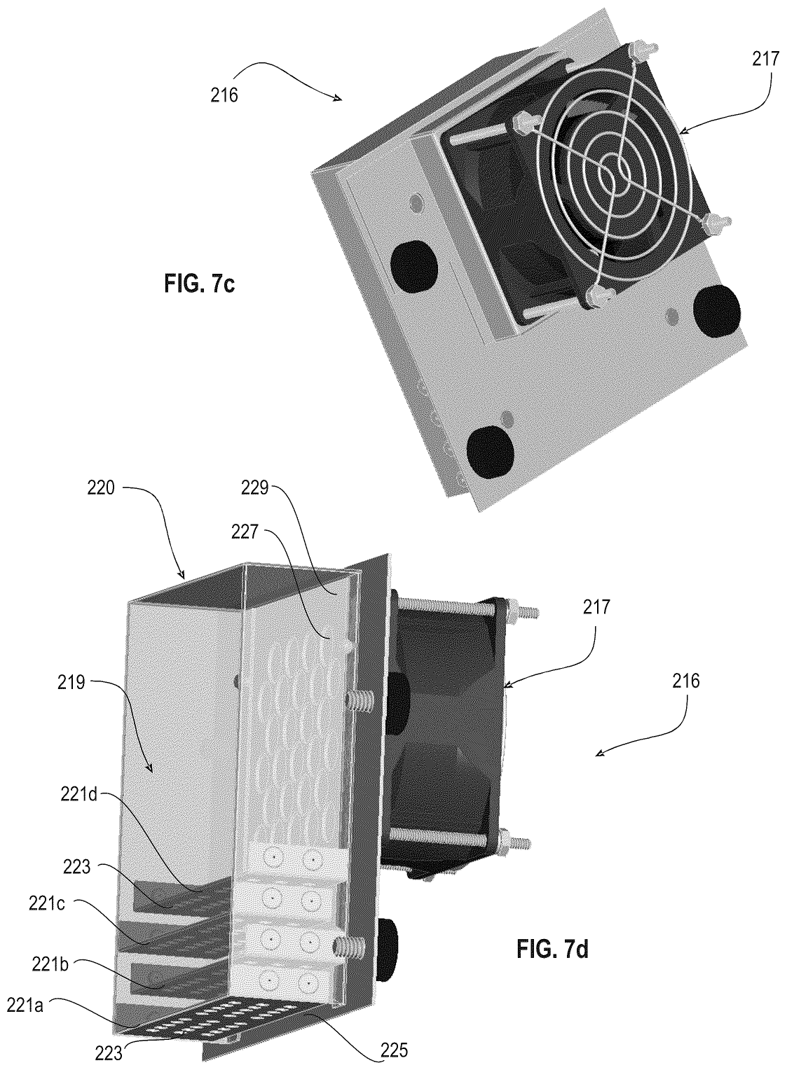

In one embodiment, the film coating device 200 further comprises a motor 214 (shown in FIG. 7b) that is operably and mechanically connected to the film tray 206 via a vibration linkage 215, and a control panel 226. The motor 214 and vibration linkage 215 are adapted to oscillate the film tray 206 to shake the excess adhesive powder 244 off the transfer film 252. The control panel 226 comprises a power switch 226A and a timer 226B. The power switch 226A is configured to activate and deactivate the film coating device 200. The timer 226B is configured to set a time period for the motor 214 to operate. In one embodiment, the timer 226B is arranged to deactivate the motor 214 after a predetermined period of time has elapsed. The control panel 226 has a dedicated power inlet 232 (FIG. 7b) for connecting a main power cord (not shown).

In an embodiment, a lever 212 is fixed to a side surface of the film coating device 200. The lever 212 is operably connected to the upper hopper 208 and the film tray 206 to activate the coating process when operated. The lever 212 is arranged for actuation from a resting position in a first direction (for example, upwards) to cause the powder retaining plate 240 to deflect downwardly (pivoting about the set of pivot arms 238A, 238B) and release the adhesive powder 244 onto the film tray 206. When released, the lever 212 is arranged to return to the resting position and the springs 254 bias the powder-retaining plate 240 into a closed position. The lever 212 is also operably connected to the motor 214 and is arranged for actuation from the resting position in a second direction (for example, downwards) to activate the motor 214 to oscillate, i.e., move back and forth at a regular speed, the film tray 206 for a predetermined time period to allow the excess adhesive powder 244 to flow into the lower hopper 210. The time period can be set using the timer 226B.

In one embodiment, an exhaust unit 216 is mounted at a rear surface of the film coating device 200. The exhaust unit 216 is adapted to draw air from inside the chamber 202 and filter the air before exhausting the air to atmosphere, thereby reducing the amount of adhesive powder 224 that escapes from the chamber 202. The exhaust fan is fixed at the rear surface of the film coating device 200 utilizing any suitable hardware. The filtering sheet is arranged for placement behind the exhaust fan to filter the air and is arranged to trap and retain excess adhesive powder 224.

Referring to FIGS. 7c and 7d, the exhaust unit 216 comprises an exhaust fan 217, an intake unit 220, and a plurality of vertically stacked baffling plates 221a, 221b, 221c, 221d, which remove some of the excess adhesive powder 244 before entering the filtering sheet. In one embodiment, the filtering sheet (not shown) may be removably inserted in a slot 225 positioned between the intake unit 220 and the exhaust fan 217. The baffling plates 221a-d are positioned within an internal chamber 219 of the intake unit 220 such that each baffling plate is slightly offset horizontally with respect to the baffling plate above and below. Each of the baffling plates 221a-d comprises a plurality of openings 223. The intake unit 220 is oriented vertically, with air being drawn in from the bottom, so that much of the excess adhesive powder 244 impacts a horizontally-oriented surface of one of the baffling plates 221a-d and falls through the openings 223 in the lower hopper 210. The interior wall 229 of the intake unit 220 that abuts the exhaust fan 217 also includes a plurality of openings 227. Some of the excess adhesive powder 244 that makes it past the baffling plates 221a-d impacts the surface of the interior wall 229 and falls back onto the baffling plates 221a-d, while the remaining excess adhesive powder 244 exits the openings 227 and impacts the filtering sheet positioned behind the exhaust fan 217. In this way, the amount of excess adhesive powder 244 that is retained by the filtering sheet is reduced, which in turn reduces the number of times the filtering sheet must be removed for cleaning or replaced.

In one embodiment, the film coating device 200 comprises an upper divertor 222 and a lower divertor 224. The upper divertor 222 is fixed at the top of the film tray 206 inside the chamber 202. The upper divertor 222 is configured to change the flow of the adhesive powder 244 to accommodate different sizes of transfer film 252. The lower divertor 224 is fixed at the bottom top of the film tray 206, also inside the chamber 202. The lower divertor 224 is configured to evenly distribute the excess adhesive powder 244 into the lower hopper 210, preventing the excess adhesive powder 244 from being dumped in one place.

In one embodiment, the chamber 202 is configured with a vibration separator 228 (FIG. 4) to isolate the chamber 202 from vibration of the film tray 206 when the motor 214 is activated. In a preferred embodiment, the vibration separator 228 can be a rubber link, such as a black neoprene rubber link.

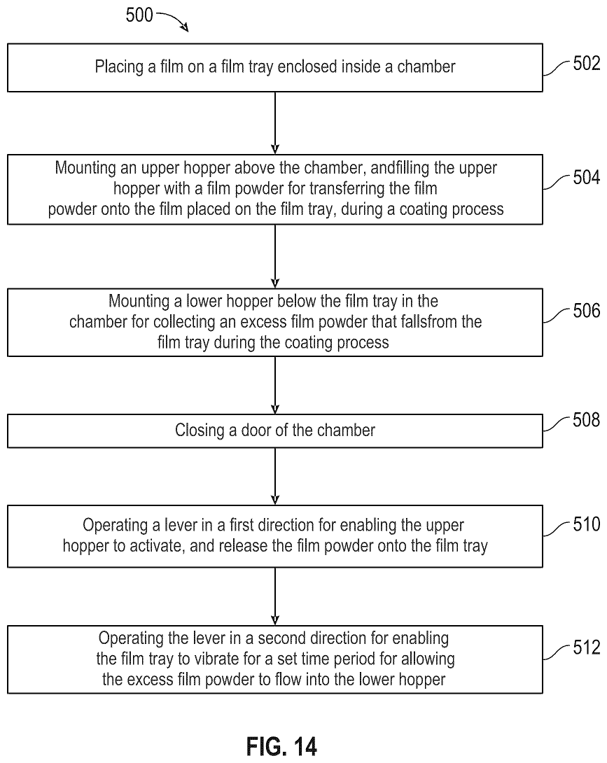

FIG. 14 is a flow diagram illustrating operation of the film coating device 200. Initially, the upper hopper 208 is filled with the adhesive powder 244 to its capacity without causing overflow, ensuring no spills occur. For example, each hopper 208, 210 may be designed to accommodate a minimum of 2.2 lbs. (1 kg) of the adhesive powder 244.

Subsequently, the upper access door 202A is opened by rotating the latch 202B 90° counterclockwise. A handle 248A may be affixed to the upper access door 202A to lift and open the upper access door 202A. Once opened, the upper hopper 208, filled with adhesive powder 244, may be slid onto one or more hopper supports 218 (FIG. 12c) and pushed to the rear of the chamber 202 to securely position the upper hopper 208 within the chamber 202 above the film tray 206. After placing the upper hopper 208 within the chamber 202, the upper access door 202A may be closed by operating the latch 202B.

Next, the door 204 of the chamber 202 is opened by pulling its handle 204A, allowing access to the chamber 202. The lower hopper 210 is then slid beneath the film tray 206 within the chamber 202. Once positioned, the lower hopper 210 is pushed to the rear of the chamber 202 to securely position the lower hopper 210 within the chamber 202.

While keeping the door 204 open, the transfer film 252 is placed onto the film tray 206. In one embodiment, the film tray 206 includes adjustable clips that allow for incremental adjustment (for example, ½ inch increments) to accommodate films of different sizes. For film sizes ranging from 19″ to 20″ in length, the upper diverter 222 may be pushed towards the rear of chamber 202. For film sizes of 16″ (A3) and smaller, the upper diverter 222 may be pulled towards the front of chamber 202. The movement of the upper diverter 222 allows for fine adjustments so the adhesive powder 244 accurately contacts the transfer film 252 in a precise location. Once the transfer film 252 is properly positioned on the film tray 206, the door 204 may be closed.

Thereafter, the lever 212 may be actuated upwardly from its resting position one or more strokes to allow the adhesive powder 244 to fall from the upper hopper 208 onto the transfer film 252. This process is repeated as often as necessary to fully coat the printed areas on the transfer film 252. The lever 212 may be arranged to include some “play” when actuated upwardly between its resting position and when it contacts the upper hopper 208.

After the printed areas on the transfer film 252 are sufficiently coated with the adhesive powder 244, the lever 212 may be actuated once downwardly to initiate the oscillation of the film tray 206 by activating the motor 214 which is operatively connected to the film tray 206. Simultaneously, the timer 226B may be set to an appropriate time period for the motor 214 to operate. Upon expiration of the time period, the motor 214 may be deactivated, and the door 204 may be opened to remove the transfer film 252 coated with the adhesive powder 244 from the chamber 202. Thereafter, a new transfer film 252 may be placed onto the film tray 206, and the process repeated. Further, the lower hopper 210 containing the excess adhesive powder 244 released from the upper hopper 208 can be swapped with the now empty upper hopper 208 for the next coating process.

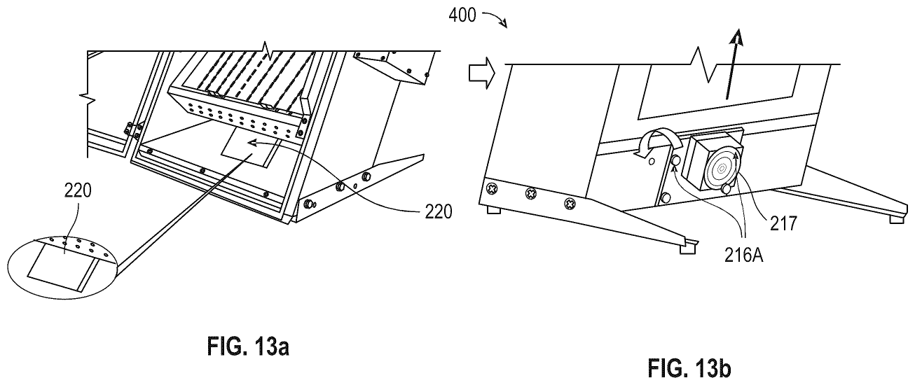

FIGS. 13a and 13b are enlarged perspective views 400 depicting a process for cleaning of the exhaust unit 216. To clean the exhaust unit 216, the lower hopper 210 is first removed from inside the chamber 202. Then, the intake unit 220 is gently tapped to loosen the adhered adhesive powder 244 from the baffling plates (FIG. 7d), allowing excess adhesive powder 244 to fall out and be removed. Upper knobs 216A may be loosened to lift up the exhaust fan 217 to gain access to the filtering sheet positioned between the exhaust fan 217 and the intake unit 220, which may be cleaned and replaced, as necessary.

FIG. 14 discloses a method 500 for coating a transfer film 252 using the film coating device 200. The method 500 comprises placing a transfer film 252 on the film tray 206 that is enclosed inside the chamber 202, as depicted in step 502.

The method 500 comprises filling the upper hopper 208 with the adhesive powder 244 and mounting the upper hopper 208 above the chamber 202 for transferring the adhesive powder 244 onto the transfer film 252 placed on the film tray 206, during the coating process, as depicted in step 504.

The method 500 comprises mounting the lower hopper 210 below the film tray 206 in the chamber 202 for collecting the excess adhesive powder 244 that falls from the film tray 206 during the coating process, as depicted in step 506. The method 500 comprises closing the door 204 of the chamber 202, as depicted in step 508.

The method 500 comprises operating the lever 212 in the first direction for enabling the upper hopper 208 to activate and release the adhesive powder 244 onto the film tray 206, as depicted in step 510. The method 500 comprises operating the lever 212 in the second direction to enable the film tray 206 to oscillate for a set time period to allow the excess adhesive powder 244 to flow into the lower hopper 210, as depicted in step 512.

The terminology used herein is for the purpose of describing particular embodiments only and is not intended to be limiting of the invention. As used herein, for example, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., upper, lower, third, etc.) is for distinction and not counting. For example, the use of “third” does not imply there must be a corresponding “upper” or “lower.” Also, if used herein, the terms “coupled” or “coupled to” or “connected” or “connected to” or “attached” or “attached to” may indicate establishing either a direct or indirect connection and is not limited to either unless expressly referenced as such.

The use of directional terms such as above, below, upper, lower, upward, downward, left, right, up-hole, downhole and the like are used in relation to the illustrative embodiments as they are depicted in the figures, the upward direction being toward the top of the corresponding figure and the downward direction being toward the bottom of the corresponding figure, the up-hole direction being toward the surface of the well and the downhole direction being toward the toe of the well.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

1. A device for applying an adhesive powder to a printed transfer film, the device comprising:
a film chamber;
a film tray located within the chamber, the film tray being shaped and positioned to removably receive a transfer film thereon;
a plurality of hoppers, each hopper having a powder-retaining chamber having a lower end and comprising a powder-retaining plate, each of the plurality of hoppers being adapted to selectively enable powder to flow though the lower end of the powder-retaining chamber when the powder-retaining plate is in an open position and to prevent powder from flowing through the lower end of the powder-retaining chamber when the powder-retaining plate is in a closed position;
an upper hopper-receiving chamber located above the chamber and adapted to removably receive any of the plurality of hoppers;
a lower hopper-receiving chamber located below the chamber and adapted to removably receive any of the plurality of hoppers;
an actuating lever that is adapted to selectively move the powder retaining plate into the open position; and
a vibration mechanism comprising a motor and a vibration linkage that mechanically connects the motor to the film tray, the vibration linkage adapted to cause the film tray to oscillate;
wherein the film chamber, film tray, and upper hopper-receiving chamber are configured to cause powder released from one of the plurality of hoppers located in the upper hopper-receiving chamber to fall on the film tray; and
wherein the chamber, film tray, and lower hopper-receiving chamber are configured to cause powder that falls from the film tray to be received in another of the plurality of hoppers located in the lower hopper-receiving chamber to fall on the film tray.

2. The device of claim 1, further comprising a timer arranged to deactivate the motor after a predetermined period of time has elapsed.

3. The device of claim 1, further comprising an agitator operably positioned within each hopper of the plurality of hoppers.

4. The device of claim 1, wherein the film tray is arranged on an incline within the chamber.

5. The device of claim 1, wherein the film chamber defines an enclosed volume and includes a door.

6. The device of claim 1, wherein the film tray comprises a film-receiving surface that is substantially planar and has a plurality of ribs extending outwardly from the planar surface.

7. The device of claim 1, wherein each of the plurality of hoppers includes at least one spring that biases the powder-retaining plate into the closed position.

8. The device of claim 1, wherein the actuating lever moves the powder retaining plate into the open position when moved in a first direction and activates the motor when moved in a second direction.

9. The device of claim 1, additionally comprising an exhaust unit positioned thereon.

10. The device of claim 1, wherein the device is portable.

11. A method for coating a transfer film, comprising:
(a) causing powder to flow from a first hopper located in an upper hopper-receiving chamber over a film sheet located on a film surface of a film tray;
(b) vibrating the film tray to remove excess powder from the film sheet; and
(c) receiving the excess powder removed from the film sheet in step (b) in a second hopper located in a lower hopper-receiving chamber the second hopper being substantially identical to the first hopper.

12. The method of claim 11, further comprising:
(c) inserting the second hopper into the upper hopper-receiving chamber;
(d) inserting the first hopper into the lower hopper-receiving chamber; and
(e) repeating step (b).

13. The method of claim 12, wherein step (b) further comprises vibrating the film tray for a predetermined period of time to remove excess powder from the film sheet.
